(19) United States
(12) Patent Application Publication
(10) Pub. No.: US 2004/0261818 A1
(43) Pub. Date: Dec. 30, 2004

(54) Method and apparatus for determining liquid flow rate

(76) Inventor: Leonardus Cornelus Robertus Winters, Nijmegen (NL)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/490,066

(22) PCT Filed: Sep. 17, 2002
(86) PCT No.: PCT/IB02/03825

(30) Foreign Application Priority Data
Sep. 20, 2001 (EP) 01203584.6
May 29, 2002 (EP) 02077111.9

(51) Int. Cl. B32B 5/02

(52) U.S. Cl. 134/3; 422/82.01; 422/82.02

(57) ABSTRACT

The present invention provides a method and related apparatus for determining the rate of flow of a liquid, the liquid comprising a first liquid delivered to a point (24) with at least a second liquid to form a solution of the first and at least second liquids, the method comprising the steps of determining the rate of flow of the at least second liquid, delivering the solution to a conductivity-measuring means (38) by which the conductivity of the solution is measured, determining the ratio between the first and the at least second liquids in the solution on the basis of the conductivity of the solution and determining the rate of flow of the first liquid on the basis of the rate of flow of the at least second liquid and said ratio and wherein the rate of flow can be employed in calibrating a flow controller controlling the rate of flow of the first liquid.

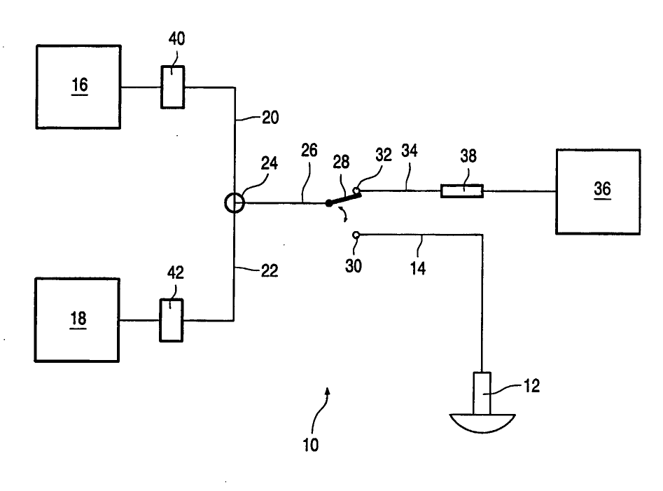

The present invention relates to a method and apparatus for determining liquid flow rate and, in particular, to such method and apparatus for use in calibrating a liquid flow controller.

The present invention also relates to a wafer cleaning method comprising such method for determining liquid flow rate.

The present invention further relates to a method of forming an electronic device comprising such method for determining liquid flow rate.

Liquid flow controllers are commonly used in the semiconductor fabrication industry for controlling the flow of chemicals and diluent which are subsequently mixed to form a solution for use in, for example, wafer-cleaning tools and wet cleaning tools in general.

It is important that such flow controllers are accurately calibrated and in order to achieve this, it is required to provide for an accurate method and apparatus for determining the rate of liquid flow.

Currently known flow controllers are calibrated by sampling the liquid passing therethrough during a measured time interval and by subsequently dividing the volume, or weight by the aforementioned sampling time interval so that the rate of flow can then be calculated.

More particularly, during the manufacture of a semiconductor device, a semiconductor wafer surface is, on a variety of occasions, exposed to a range of potential contamination elements. A wet-cleaning process is commonly employed so as to maintain a low baseline level of contamination during the semiconductor device fabrication process. A typical wet-cleaning process commonly involves a sequence of introducing a solution of one or more chemicals such as, for example, ammonia, hydrogen peroxide, hydrofluoric acid, hydrochloric acid, sulfuric acid etc, mixed with a diluent such as, for example, water.

In the majority of the equipment employed for such wet-cleaning processing, the cleaning solutions are prepared by the in-line mixing of one or more of such chemicals as noted above with the diluent. Accurately calibrated flow controllers are used to control the flows of the separate chemicals and the diluent upstream of the point of mixture.

As mentioned above in general terms, the calibration of such flow controllers currently involves a procedure whereby the chemical, or diluent as appropriate, is dispensed with during a measured time frame and the volume or weight of the sample collected during that time frame is recorded and the flow rate determined by dividing the recorded value of volume or weight by the time frame interval. It is currently known to provide some commercial cleaning tools with a vessel containing a low-level liquid sensor and a high-level liquid sensor wherein the volume of liquid found between the two sensors is known. Therefore, this provides for a partly automated procedure whereby the time taken to deliver the then known volume can readily be determined and allowed for the subsequent ready determination of the flow rate.

More recent developments in the field of wet-cleaning, however, have tended towards the employment of lower concentration levels of cleaning solutions having regard to cost, cleaning performance and environmental factors.

In order to meet the new demands resulting from such factors, low-flow controllers are required and those that are currently commercially available are capable of measuring flows of liquid chemicals down to a rate in the order of a few ml/min.

Although such known flow controllers can readily provide for such low flow rates, the above-mentioned procedure for calibrating these low flow controllers is not readily suitable for calibrating the controllers. Such a calibration procedure proves to be extremely time consuming due to the relatively large volume of the commercially available calibration vessels. However, any reduction in the dimensions of such vessels would lead to a decrease in the accuracy of the measurement.

The present invention therefore seeks to provide a method and apparatus for determining a liquid flow which does not lead to disadvantages of the nature discussed above, and which could therefore be readily employed in a method and apparatus for calibrating a liquid flow controller.

According to one aspect of the present invention, there is provided a method of determining the rate of flow of a liquid, the liquid comprising a first liquid delivered to a point with at least a second liquid to form a solution of the first and at least second liquids, the method comprising the step of determining the rate of flow of the at least second liquid, and characterized by the steps of:

delivering the solution to a conductivity-measuring means by which the conductivity of the solution is measured;

determining the ratio between the first and the at least second liquids in the solution on the basis of the conductivity of the solution; and

determining the rate of flow of the first liquid on the basis of the rate of flow of the at least second liquid and said ratio.

By employing a conductivity-measuring means it is found that the measurement of the flow rate can be advantageously performed in an in-line reliable, accurate and quick manner.

Relatively fast and accurate measurements of liquid flow rates can therefore be achieved and readily used to allow for the accurate calibration of liquid flow controllers within, for example, a wafer-cleaning tool through measurement of the conductivity of the cleaning solution.

Further, by measuring the conductivity of the solution, the liquid flow measurement, and any subsequent calibration of the liquid flow controller, can be readily automated.

The feature of claim 2 is advantageous in maintaining the accuracy of liquid flow measurement.

The feature of claim 3 is particularly advantageous in providing for ready automated incorporation of the method into an appropriate solution delivery apparatus.

The feature of claim 4 advantageously relates the present invention to a cleaning tool employing a solution formed from liquids requiring a highly accurate flow rate.

The features of claims 5-8 are particularly relevant to the advantageous employment of the method of the present invention when calibrating a liquid flow controller.

The features of claims 9 and 10 are particularly advantageous in relating the method of the present invention to use within a wet-cleaning tool for cleaning a semiconductor wafer during semiconductor device fabrication.

The features of claims 11 and 12 advantageously relate the present invention to use during the manufacture of an electronic device, in particular but not exclusively a semiconductor device.

The features of claims 13-15 are particularly advantageous in providing an apparatus for advantageously employing the method of the present invention.

Whereas the liquid flow measurement and calibration procedure disclosed herein can be readily automated and incorporated, for example a spray tool or wet-cleaning tool that are arranged to deliver the chemical mixture via a conductivity probe, it should be appreciated that the invention is also applicable to wet-cleaning tools and liquid flow controllers, in general.

The invention is described further hereinafter with reference to the accompanying drawing which comprises a block diagram of a wet tool solution delivery system according to one embodiment of the present invention.

Turning to the FIGURE, there is illustrated a liquid deliver system 10 for delivering a cleaning solution to a delivery head 12 of a spray tool, or indeed alternatively any form of wet-cleaning tool, and which is arranged to receive the cleaning solution by means of a supply line 14.

The solution is formed from a diluent, for example water, stored in a water reservoir 16, and at least one cleaning chemical stored in a chemical reservoir 18.

The water is delivered from the reservoir 16 via a supply line 20, and the chemical is delivered from the reservoir 18 via a supply line 22, respectively, to a point 24 which causes mixture of the water and chemical so as to form the solution which is then delivered by a supply channel 26 to a two-way valve 28. The outlet to the two-way valve 28 leading from the supply line 26 is switched to be connected to either an inlet 30 for the supply line 14 leading to the delivery head 12 of the spray tool, or to an opening 32 in a discharge line 34 which delivers the solution to dump reservoir 36.

The solution delivered by means of the discharge line 34 towards the dump reservoir 36 passes by means 38 for measuring the conductivity of the solution. In the illustrated example such means 38 comprise a conductivity probe which is effectively located in the discharge line 34.

The drawing also illustrates a flow controller 40 provided in the supply line 20 leading from the water reservoir 16 to the mixing point 24, and a flow controller 42 found in the supply line 22 leading from the chemical reservoir 18 to the mixing point 24.

The section of the system 10 formed by the discharge line 34, conductivity probe 38 and dump reservoir 36 forms means for measuring the flow of solution through the delivery line 26 and, when the valve 28 is appropriately switched to the opening 30, onward through the supply line 14 to the delivery head 12 of the spray tool.

In accordance with a particular embodiment of the present invention, an advantageously accurate measurement of the flow of the solution through the supply 26 can be achieved and which serves to accurately determine the flow of the chemical from the reservoir 18 through the flow controller 42.

The invention allows for the ready and accurate calibration of the flow controller 42 even though, in accordance with current requirements, the percentage of chemical 18 within the solution virtually delivered by the delivery head 12 of a spray tool is lower than previously required.

Since, however, the flow of water from the reservoir 16 via the supply 20 to the mixing point 24 need not to be so reduced, the flow controller 40 can be calibrated in accordance with current methods whereby the volume of water delivered through the flow controller during a predetermined period is measured such that the flow rate through the controller 40 can therefore be determined and the controller 40 thereby accurately calibrated.

An accurate measurement of the flow of water along the supply line 20 is also required in accordance with the present invention with regard to the measurement of the rate of flow of the liquid chemical from the reservoir 18 along the supply line 22 and into the solution delivered by way of the supply line 26.

In accordance with this illustrated embodiment of the present invention, when it becomes necessary to calibrate the flow controller 42 delivering the fluid chemical from the chemical reservoir 18, the valve 28 is switched so as to deliver solution to the opening 32 in the discharge line 34 such that the conductivity probe 38 can then determine the ratio of the chemical in the solution to the diluent through measurement of the conductivity of the solution.

Since the flow rate of the diluent through the flow controller 40 has already been determined accurately, the flow rate of the chemical through the flow controller 42 can readily be determined from a calculation based upon the known flow rate of the diluent and the chemical/diluent ratio measured by means of the conductivity probe 38.

Once the flow controller 42 has been accurately calibrated in this manner, the valve 28 can be switched back so as to deliver the solution to the opening 30 in the supply line 40 such that the solution delivered by means of the supply line to the delivery head 12 of the spray tool can be accurately controlled by means of the flow controllers 40, 42.

It should be appreciated that the above-mentioned aspects are also dependent upon the accuracy of the conductivity-measuring tool. This tool itself can readily be calibrated using different accurate dilutions of the chemical in the diluent which can be delivered as required by means of an associated delivery system (not shown) and which can connect to the inlet 32 in the discharge line 34.

Also, the invention is not restricted to the details of the foregoing embodiment. For example, the measuring device could be included in line 14 so as to enhance frequent, or even continuous, measurements of the solution as it is delivered to the delivery head 12. The valve 28 and reservoir 36 would not be required then.

1. A method of determining the rate of flow of a liquid, the liquid comprising a first liquid delivered to a point with at least a second liquid to form a solution of the first and at least second liquids, the method comprising the step of determining the rate of flow of the at least second liquid, and characterized by the steps of:
delivering the solution to a conductivity-measuring means by which the conductivity of the solution is measured;
determining the ratio between the first and the at least second liquids in the solution on the basis of the conductivity of the solution; and
determining the rate of flow of the first liquid on the basis of the rate of flow of the at least second liquid and said ratio.

2. A method as claimed in claim 1 and including the step of calibrating the conductivity measuring means through the application of different accurate dilutions of the first liquid in the at least second liquid.

3. A method as claimed in claim 1, wherein the determination of the conductivity of the solution is carried out insitu in a solution delivery system.

4. A method as claimed in claim 1, and employed for determining the rate of flow of a liquid in a cleaning tool.

5. A method as claimed in claim 1, wherein the flow of the first liquid is passed through a first liquid flow controller for controlling the rate of flow of the first liquid towards the mixing point.

6. A method as claimed in claim 5 and employed in the calibration of said first liquid flow controller.

7. A method as claimed in claim 1, wherein the rate of flow of said at least second liquid is determined via a second liquid flow controller.

8. A method as claimed in claim 7, wherein said second liquid flow controller is calibrated by reference to the volume of a weight of said second liquid delivered in a known time frame.

9. A method as claimed in claim 1, and employed in a wet cleaning tool.

10. A method as claimed in claim 1, wherein said at least second liquid comprises a diluent.

11. A wafer cleaning method including the steps of delivering a solution to a chamber accommodating the wafer and determining the rate of flow of a liquid forming at least part of the solution in accordance with a method of claim 1.

12. A method of forming an electronic device, in particular but not exclusively a semiconductor device, including the step of exposing at least a part of the device to a solution and determining the rate of flow of a liquid forming at least part of the solution in accordance with a method of claim 1.

13. An apparatus for determining the rate of flow of a liquid, comprising:
first liquid delivery means for delivering a first liquid to a point of mixture with at least a second liquid delivered by means of second liquid delivery means so as to form a solution of said first and at least second liquids, including means for determining the rate of flow of the at least second liquid and characterized by conductivity measuring means located in the flow path of the solution for determining the conductivity of the solution;
means for determining the ratio between the first and at least second liquids within the solution on the basis of the conductivity of the solution; and
means for determining the rate of flow of the first liquid on the basis of the determined value of the rate of flow of the at least second liquid and the determined value of said ratio.

14. An apparatus as claimed in claim 13 and arranged to carry out the method steps according to claim 2.

15. A wet cleaning apparatus comprising an apparatus as claimed in claim 13.
